(19) United States
(12) Patent Application Publication
(10) Pub. No.: US 2025/0198456 A1
(43) Pub. Date: Jun. 19, 2025

(54) ROLLING ELEMENT RETAINER, SLIDE MEMBER AND LIMITED-STROKE LINEAR GUIDE

(71) Applicant: CHIEFTEK PRECISION CO., LTD., TAINAN CITY (TW)

(72) Inventor: MING-CHE HSU, TAINAN CITY (TW)

(21) Appl. No.: 18/967,408

(22) Filed: Dec. 3, 2024

(30) Foreign Application Priority Data
Dec. 14, 2023 (TW) 112148760

(51) Int. Cl. F16C 29/04; F16C 29/00

(52) U.S. Cl. CPC F16C 29/043; F16C 29/002; F16C 29/005

(57) ABSTRACT

A rolling element retainer, a slide member and a limited-stroke linear guide are disclosed. Rolling elements are placed in the rolling element retainer to form the slide member. The slide member is disposed between two fixed-length rails to form the limited-stroke linear guide. The rolling element retainer includes a body, a plurality of accommodating holes distributed on the body for accommodating rolling element, and a plurality of apertures formed on the body and located between the accommodating holes. Lubricants are stored in the apertures, which can provide lubrication when the rolling elements roll. The body has a polygonal profile and at least four protruding portions protruding away from the body. The protruding portions extend continuously across all the adjacent accommodating holes. In this way, the rolling element retainer has better rigidity and more accommodating holes to accommodate more rolling elements, thereby improving the load capacity of the limited-stroke linear guide.

### FIELD OF THE INVENTION

The present invention relates to a rolling element retainer, a slide member, and a limited-stroke linear guide, and more particularly to a rolling element retainer having accommodating holes for accommodating rolling elements and apertures located between the accommodating holes and communicating with the accommodating holes for storing lubricating grease or porous lubricants to provide lubrication for the rolling elements. The rolling element retainer has protruding portions extending continuously and spanning all the adjacent accommodating holes, so that the rolling element retainer has higher rigidity.

### BACKGROUND OF THE INVENTION

A limited-stroke linear guide includes two fixed-length rails that can move relative to each other. A slide member is provided between the two fixed-length rails for assisting in the relative movement of the two fixed-length rails. The slide member includes a retainer with a specific length and a plurality of rolling elements spaced apart by the retainer. The rolling elements roll on the raceway surfaces and bear the load. Limited-stroke linear guides are generally used in machining processes with short travel distances.

As disclosed in U.S. Pat. No. 8,360,644B2, titled “LINEAR MOTION GUIDE UNIT WITH CAGE”, the linear motion guide unit has a platy cage. The cage has openings arranged along a lengthwise direction. Rollers are obliquely disposed in the respective openings. Adjacent recesses 23 and lips 2 are disposed around the openings for retaining the rolling elements.

As disclosed in U.S. Pat. No. 8,360,644B2, the cage is platy. The retainer is thinner and less rigid. In order to maintain sufficient strength of the cage, the number of openings arranged along the lengthwise direction of the cage must be reduced and a smaller number of rolling elements are placed in the openings, resulting in a lower load on the limited-stroke linear rail. In addition, this patent does not consider how to lubricate the rolling elements to maintain smooth rolling.

As disclosed in German Patent No. DE3709039C2, titled “LINEAR ROLLER BEARING RETAINER”, the retainer is composed of a plurality of retainer units connected in series. The retainer units each have a receiving groove. A rolling element is placed in the receiving groove. The adjacent retainer units are connected through locking portions 13 on the end face to be elastically locked in locking holes 16. In order to facilitate the elastic deformation of the locking portions 13 to be locked in the locking holes 16, the locking portions 13 each have a through hole for the space required for deformation.

As disclosed in German Patent No. DE3709039C2, the retainer covers the rolling elements (pocket type) and has higher rigidity compared with the aforementioned U.S. Pat. No. 8,360,644B2. However, the through hole of the locking portion 13 is configured for the space required for the deformation of the locking portion. This patent does not consider how to lubricate the rolling elements when they are rolling to ensure smooth rolling of the rolling elements.

As disclosed in Japanese Patent No. JP2021012648, titled “LINEAR GUIDE DEVICE”, the retainer is composed of a first segment and a second segment that are butted. As shown in FIG. 9 and FIG. 10 of this patent, the rectangular retainer body 40 has anti-falling portions extending in the longitudinal direction at the upper and lower corners and segmented protruding portions adjacent to the receiving groove at the left and right corners. The rolling elements are retained by the anti-falling portions and the segmented protruding portions. Furthermore, the retainer is equipped with a toothed wheel to prevent slippage. Recesses 25 are formed on the first segment and the second segment of the retainer for receiving the axle of the toothed wheel.

As disclosed in Japanese Patent No. JP2021012648, the retainer has the anti-falling portions and the segmented protruding portions to retain the rolling elements, which further improves the structural rigidity of the retainer. However, the segmented protruding portions at the left and right sides do not extend the full length across all the rolling elements, and the tensile strength against the axial tensile force generated by the axial sliding of the rails is lower. This patent does not consider how to lubricate the rolling elements to ensure smooth rolling of the rolling elements. Besides, when the retainer is equipped with the toothed wheel, the axle of the toothed wheel is connected to the recesses 25 of the retainer in an external connection manner, which may cause instability of the toothed wheel.

### SUMMARY OF THE INVENTION

According to one aspect of the present invention, a rolling element retainer is provided. The rolling element retainer comprises a body, a plurality of accommodating holes, and a plurality of apertures. The body extends along a path. In a longitudinal direction, the body has a polygonal profile and at least four protruding portions protruding away from the body. The accommodating holes are distributed in the body along the path and located among the protruding portions. The accommodating holes are spaced apart by a distance. The accommodating holes each accommodate a rolling element. The apertures are formed on the body and located between the accommodating holes. The apertures communicate with the accommodating holes. The apertures are configured for storing lubricating grease or a porous lubricant. At least one of the protruding portions extends along the path and spans all the adjacent accommodating holes.

Preferably, the accommodating holes each have a width slightly greater than that of the rolling element. The accommodating holes each have an opening on the body. The opening has a width slightly less than that of the rolling element. The rolling element is placed in the accommodating hole via the opening by applying force, without falling off freely. The rolling element has a rolling surface extending out of the body.

Preferably, the rolling element retainer is composed of a first segment and a second segment. The first segment and the second segment extend along the path and are coupled to each other on a coupling surface by means of corresponding coupling portions.

Preferably, a spindle is integrally formed with the body in the longitudinal direction. A rotatable toothed wheel is pivotally connected to the spindle. The body has a notch corresponding in position to the toothed wheel. The toothed wheel partially extends out of the notch. The rolling element retainer is composed of a first segment and a second segment. The first segment and the second segment extend along the path and are coupled to each other on a coupling surface by means of corresponding coupling portions. The coupling surface is parallel to an axis of the toothed wheel.

Preferably, the path is a straight path or a curved path.

According to another aspect of the present invention, a slide member is provided. The slide member comprises the foregoing rolling element retainer. The accommodating holes each accommodate the rolling element.

Preferably, the rolling element is a roller or a ball.

Preferably, rolling axes of adjacent ones of the rolling elements in the accommodating holes are staggered with respect to each other.

According to a further aspect of the present invention, a limited-stroke linear guide is provided. The limited-stroke linear guide comprises the foregoing rolling element retainer and two fixed-length rails. The accommodating holes each accommodate the rolling element. Opposite sides of the two fixed-length rails each have a raceway groove. The raceway grooves of the two fixed-length rails define a raceway space in the longitudinal direction. The raceway space has a contour corresponding to that of the rolling element retainer. The rolling element retainer is disposed in the raceway space. The rolling element rolls along the raceway groove. The raceway space is formed with a rail gap and a receiving groove in the longitudinal direction. The protruding portions are located in the rail gap and the receiving groove.

Preferably, the two fixed-length rails each have a toothed groove corresponding to the toothed wheel. The toothed wheel meshes with the toothed groove.

According to the above technical features, the present invention can achieve the following effects:

1. The rolling element retainer has the plurality of apertures formed between the accommodating holes of the body. The apertures communicate with the adjacent accommodating holes. The aperture stores lubricating grease or a porous lubricant for providing lubrication when the rolling element rolls, which can prevent the rolling element from rolling unsmoothly and causing vibration of the two fixed-length rails when they move relative to each other.

2. In the longitudinal section of the rolling element retainer, the protruding portions pass through the corners of each accommodating hole along the axial direction. All the protruding portions distributed around the corners of the accommodating holes provide better connection strength between the adjacent accommodating holes, which can improve the rigidity of the rolling element retainer effectively and enable the rolling element retainer to have greater tensile strength in the axial direction. Through the protruding portions to improve the rigidity of the rolling element retainer, the rolling element retainer of the same length has more accommodating holes to accommodate more rolling elements, so that the limited-stroke linear guide has greater load capacity and prevents breakage of the body due to external forces during assembly or use.

3. In the longitudinal section of the rolling element retainer, the accommodating space of the accommodating hole extends to the protruding portions, thereby allowing the exposed surface of the roller to have a larger contact area.

4. The toothed wheel is disposed at the middle section of the rolling element retainer, and the toothed wheel meshes with the toothed grooves of the two fixed-length rails. When the two fixed-length rails move relative to each other, the rolling element retainer is kept in place to slide relative to the two fixed-length rails without creeping. The spindle of the toothed wheel is integrally formed with the body of the rolling element retainer, which does not need to be assembled separately to ensure the perpendicularity of the spindle and allows the toothed wheel to rotate stably.

### BRIEF DESCRIPTION OF THE DRAWINGS

FIG. 1 is a perspective view of the rolling element retainer and the slide member according to a first embodiment of the present invention;

FIG. 2 is a sectional view of FIG. 1;

FIG. 3 is a sectional view of FIG. 2;

FIG. 4 is another sectional view of FIG. 2;

FIG. 5 is a perspective view of the limited-stroke linear guide according to the first embodiment of the present invention;

FIG. 6 is a front view of FIG. 5;

FIG. 7 is a perspective view of the rolling element retainer according to a second embodiment of the present invention;

FIG. 8 is a front view of FIG. 7;

FIG. 9 is a sectional view of FIG. 7;

FIG. 10 is a perspective view of the slide member according to the second embodiment of the present invention;

FIG. 11 is a perspective view of the limited-stroke linear guide according to the second embodiment of the present invention;

FIG. 12 is an exploded view of the rolling element retainer according to a third embodiment of the present invention, wherein the rolling element retainer is composed of the first segment and the second segment;

FIG. 13 is a perspective view of the rolling element retainer according to the third embodiment of the present invention, wherein the rolling element retainer is composed of the first segment and the second segment;

FIG. 14 is a planar schematic view of the rolling element retainer according to the third embodiment of the present invention, wherein the rolling element retainer is composed of the first segment and the second segment;

FIG. 15 is a sectional view of FIG. 14;

FIG. 16 is another sectional view of FIG. 14;

FIG. 17 is an exploded view of the rolling element retainer according to a fourth embodiment of the present invention, wherein the rolling element retainer is composed of the first segment and the second segment;

FIG. 18 is a front view of the segment in FIG. 17;

FIG. 19 is a sectional view of the segment in FIG. 17;

FIG. 20 is a perspective view of the rolling element retainer according to the fourth embodiment of the present invention, wherein the rolling element retainer is composed of the first segment and the second segment;

FIG. 21 is a planar schematic view of the rolling element retainer according to the fourth embodiment of the present invention, wherein the rolling element retainer is composed of the first segment and the second segment;

FIG. 22 is a sectional view of FIG. 21;

FIG. 23 is a perspective view of the rolling element retainer and the slide member according to a fifth embodiment of the present invention;

FIG. 24 is a sectional view of FIG. 23;

FIG. 25 is a sectional view of FIG. 24;

FIG. 26 is a perspective view of the limited-stroke linear guide according to the fifth embodiment of the present invention;

FIG. 27 is a front view of the segment in FIG. 26;

FIG. 28 is a perspective view of the rolling element retainer and the slide member according to a sixth embodiment of the present invention; and

FIG. 29 is a perspective view of the rolling element retainer and the slide member according to a seventh embodiment of the present invention.

### DESCRIPTION OF THE PREFERRED EMBODIMENTS

Embodiments of the present invention will now be described, by way of example only, with reference to the accompanying drawings.

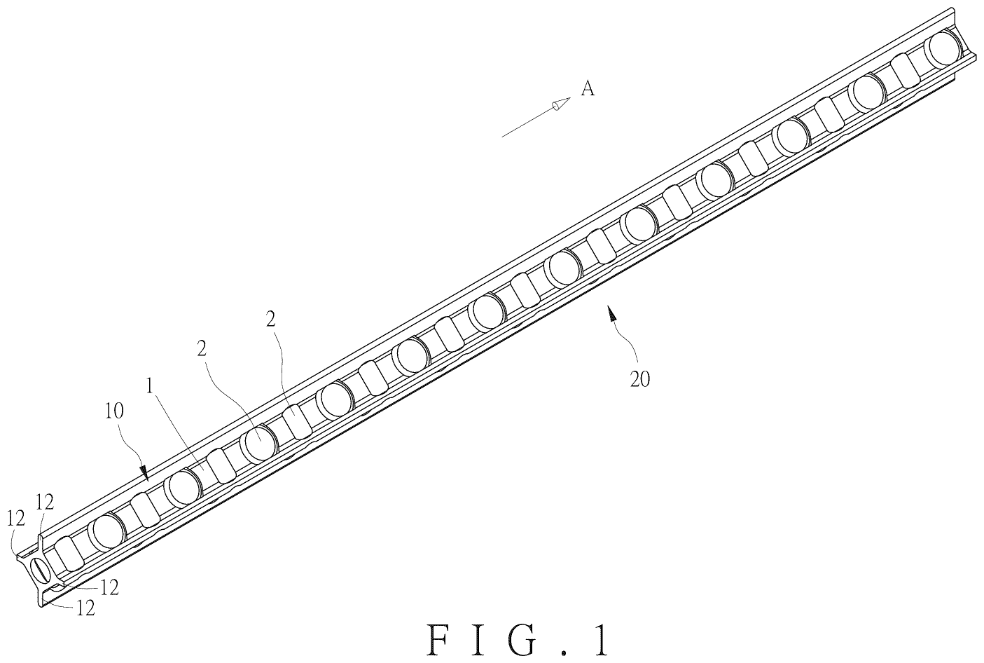

The present invention discloses a rolling element retainer, a slide member, and a limited-stroke linear guide. FIG. 1 illustrates a rolling element retainer 10 and a slide member 20 according to a first embodiment of the present invention. The rolling element retainer 10 is integrally formed and includes a body 1. The body 1 is polygonal and made of a rigid material such as stainless steel. The body 1 extends along a path. The path may be a straight path or a curved path, as desired. In this embodiment, the body 1 extends along a straight path, for example, an axial direction. A plurality of rolling elements 2 are placed in the body 1 of the rolling element retainer 10 to form the slide member 20. In this embodiment, the rolling elements 2 are rollers. The rolling axes of adjacent ones of the rolling elements 2 are staggered with respect to each other. For example, the rolling axes of adjacent ones of the rolling elements 2 are staggered with respect to each other by 90 degrees.

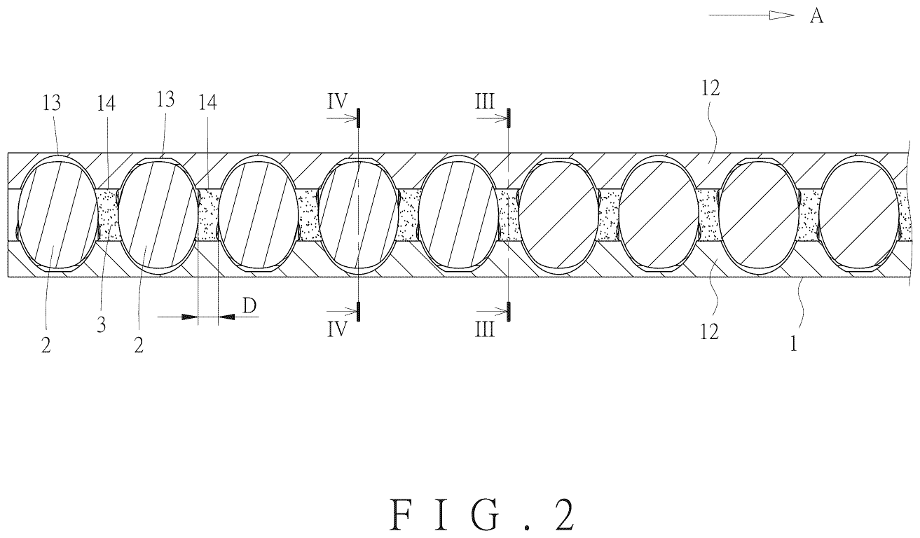

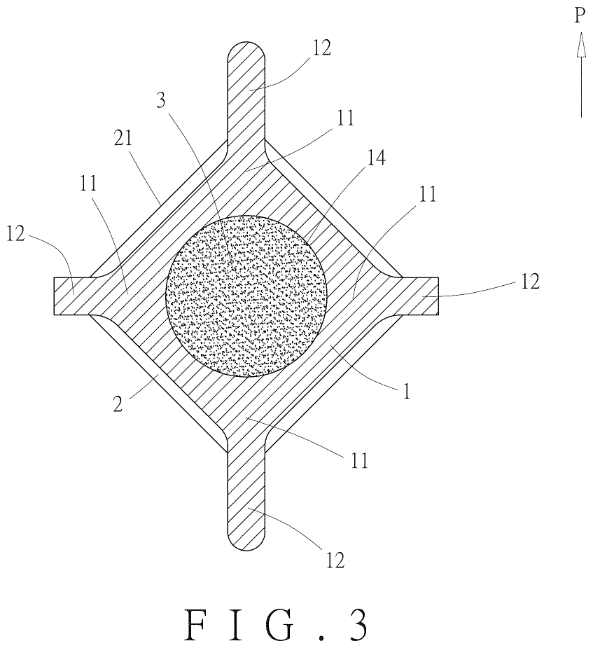

Referring to FIG. 2 and FIG. 3, specifically, in a longitudinal direction P, the profile of the body 1 includes a plurality of corners 11. In this embodiment, the body 1 is rectangular and includes four corners 11 with at least four protruding portions 12 protruding away from the body 1. In this embodiment, the body 1 has four protruding portions 12 protruding away from the body 1 at the four corners 11. The rolling element retainer 10 has a plurality of accommodating holes 13 distributed in the body 1 along the axial direction A and located among the protruding portions 12. The accommodating holes 13 are spaced apart by a distance D. The protruding portions 12 extend along the axial direction A and span all the accommodating holes 13. The width of the accommodating hole 13 is slightly greater than the width of the rolling element 2, so that the rolling elements 2 can be accommodated in the accommodating holes 13, respectively. After the rolling element 2 is placed in the accommodating hole 13, the rolling element 2 has a rolling surface 21 extending out of the body 1. A plurality of apertures 14 are formed between the accommodating holes 13 of the body 1. The apertures 14 communicate with the accommodating holes 13. The aperture 14 stores lubricating grease or a porous lubricant. In this embodiment, a porous lubricant 3 is provided in the aperture 14 as an example.

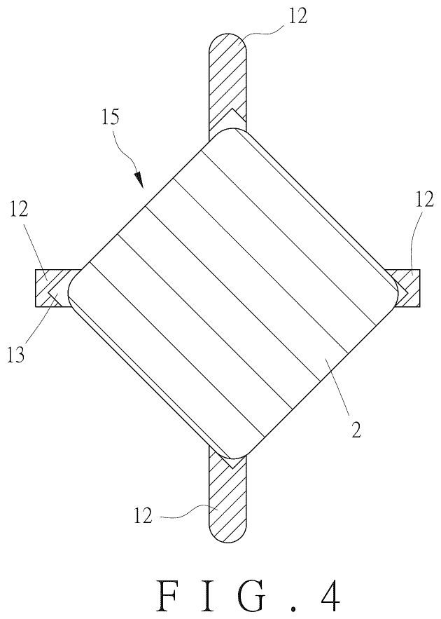

Referring to FIG. 4, in this embodiment, the accommodating hole 13 has an opening 15 on the body 1. The width of the opening 15 is slightly less than the width of the rolling element 2. The body 1 allows for a slight elastic deformation, so that the rolling element 2 is placed in the accommodating hole 13 via the opening 15 by applying force. The rolling element 2 will not fall off freely from the opening 15 after being placed in the accommodating hole 13.

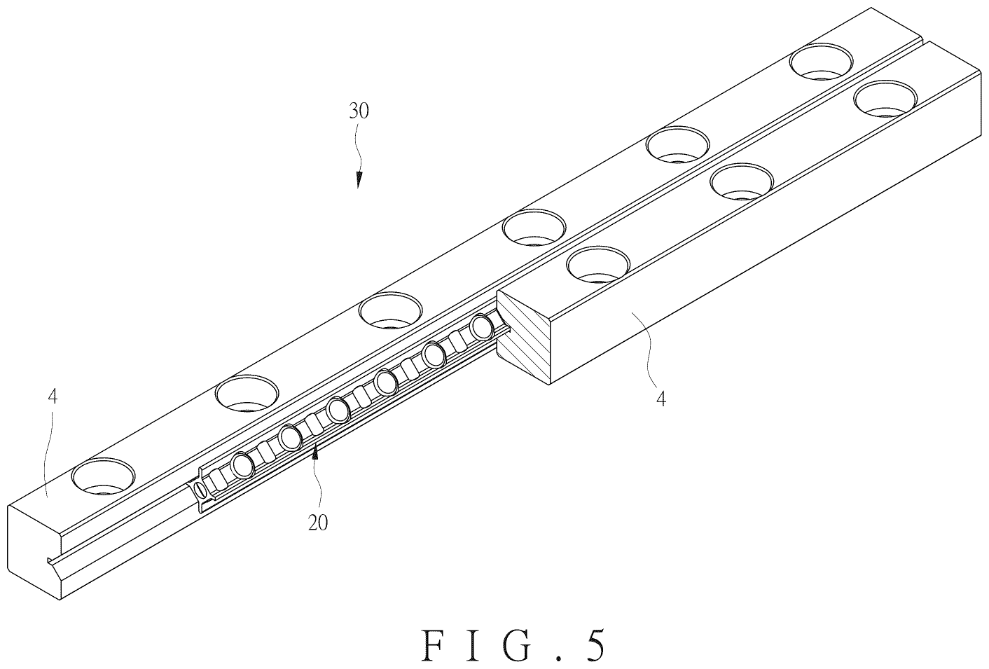

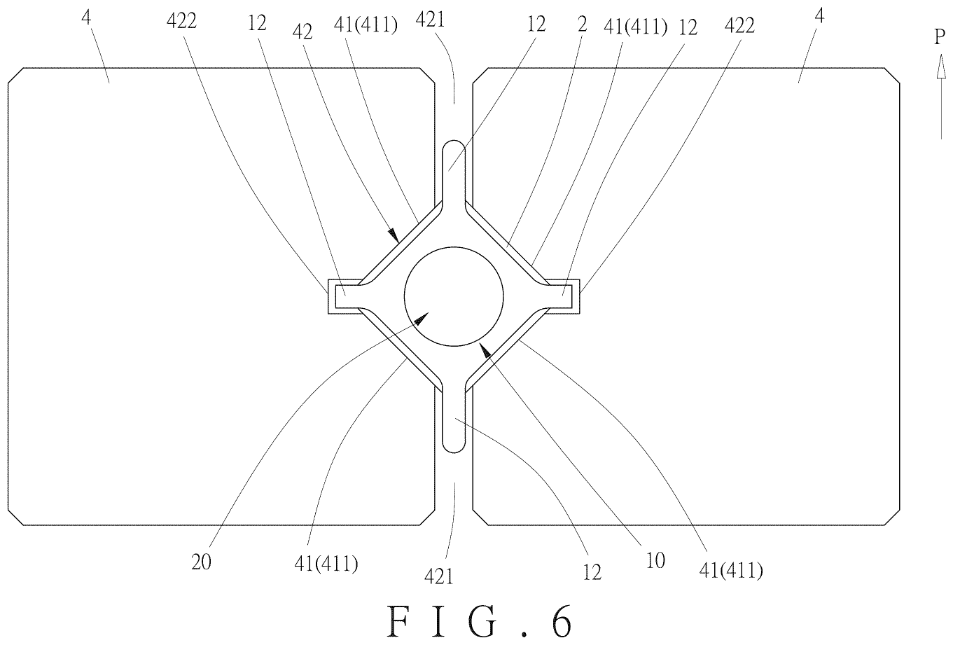

Referring to FIG. 5 and FIG. 6, a limited-stroke linear guide 30 according to the first embodiment of the present invention comprises two fixed-length rails 4 and the slide member 20 mounted between the two fixed-length rails 4. The slide member 20 assists the two fixed-length rails 4 in moving relative to each other. The opposite sides of the two fixed-length rails 4 each have a raceway groove 41. The inner surface of the raceway groove 41 is defined as a raceway surface 411. The raceway grooves 41 of the two fixed-length rails 4 define a raceway space 42. The slide member 20 is disposed in the raceway space 42, so that the rolling elements 2 roll along the raceway surfaces 411 of the raceway grooves 41 of the two fixed-length rails 4. In the longitudinal direction P, the raceway space 42 is formed with a rail gap 421 and a receiving groove 422. The protruding portions 12 are located in the rail gap 421 and the receiving groove 422. As shown in FIG. 6, two fixed-length rails 4 are located on the left and right sides. The two fixed-length rails 4 are each formed with the receiving groove 422 for receiving the protruding portions 12 on the left and right sides of the rolling element retainer 10. The two fixed-length rails 4 are spaced apart to form the rail gaps 421 on the upper and lower sides for receiving the protruding portions 12 on the upper and lower sides of the rolling element retainer 10.

As shown in FIG. 3, the porous lubricant 3 placed in the aperture 14 between every adjacent two of the accommodating holes 13 on the body 1 provides lubrication when the rolling element 2 rolls. This can prevent the rolling element 2 from rolling unsmoothly and causing vibration of the two fixed-length rails 4 when they move relative to each other.

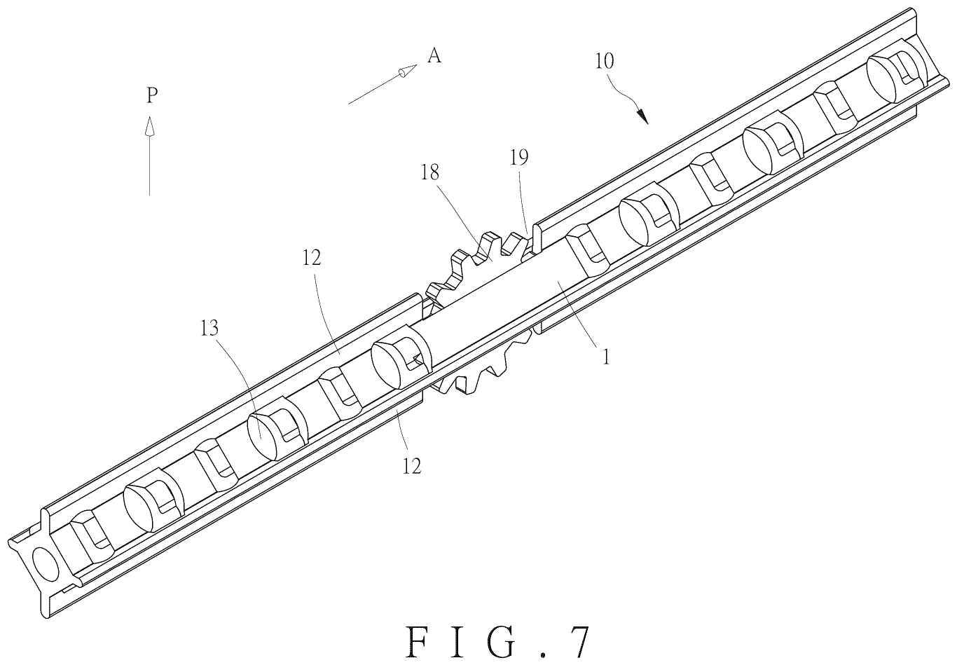

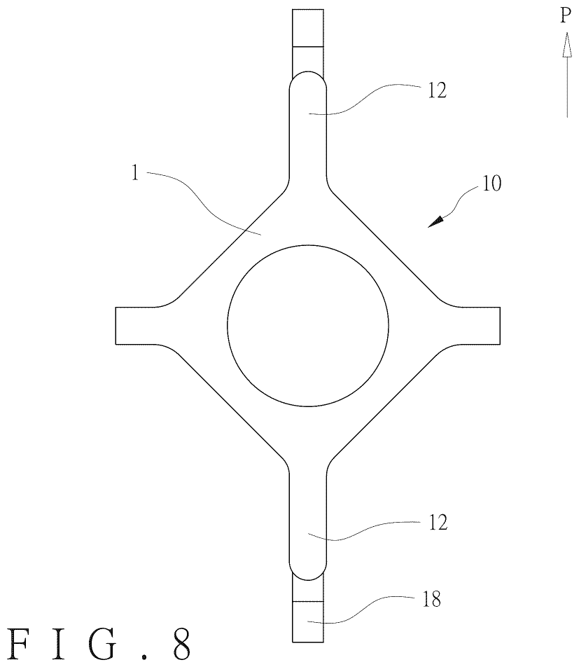

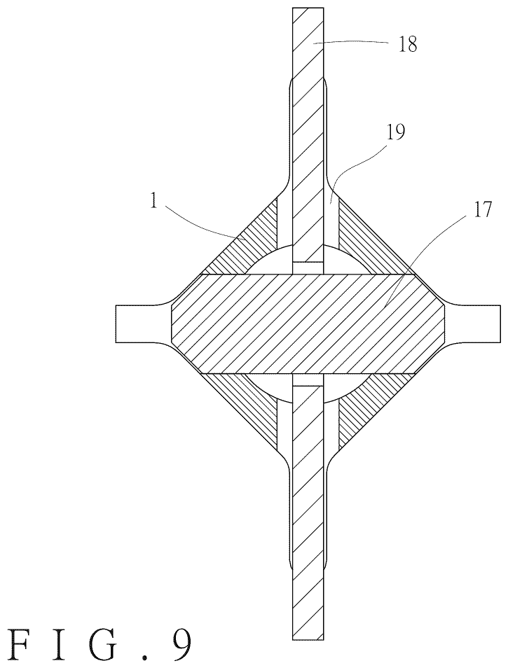

FIG. 7, FIG. 8 and FIG. 9 illustrate a rolling element retainer 10 according to a second embodiment of the present invention. The rolling element retainer 10 has a notch 19 at the middle section of the body 1 in the axial direction A. A rotatable toothed wheel 18 is connected to the notch 19. The toothed wheel 18 partially extends out of the notch 19. In the longitudinal direction P, the length of the toothed wheel 18 is slightly greater than the protruding length of the two opposite protruding portions 12. In this embodiment, a spindle is integrally formed with the body 1. The toothed wheel 18 is pivotally connected to the spindle 17. Through the spindle 17 that is integrally formed with the body 1, the toothed wheel 18 can be easily assembled on the body 1, and the perpendicularity of the spindle 17 can be ensured so that the toothed wheel 18 can rotate stably.

In the second embodiment, all the accommodating holes 13 located on one side of the toothed wheel 18 along the axial direction A are defined as one set of “adjacent” accommodating holes 13; all the accommodating holes 13 located on the other side of the toothed wheel 18 along the axial direction A are defined as another set of “adjacent” accommodating holes 13. The two accommodating holes 13 closest to the toothed wheel 18, separated from the toothed wheel 18, are located on the two sides of the toothed wheel 18. The two spaced accommodating holes 13 are not adjacent to each other, and are not “adjacent” accommodating holes 13 as defined in the present invention.

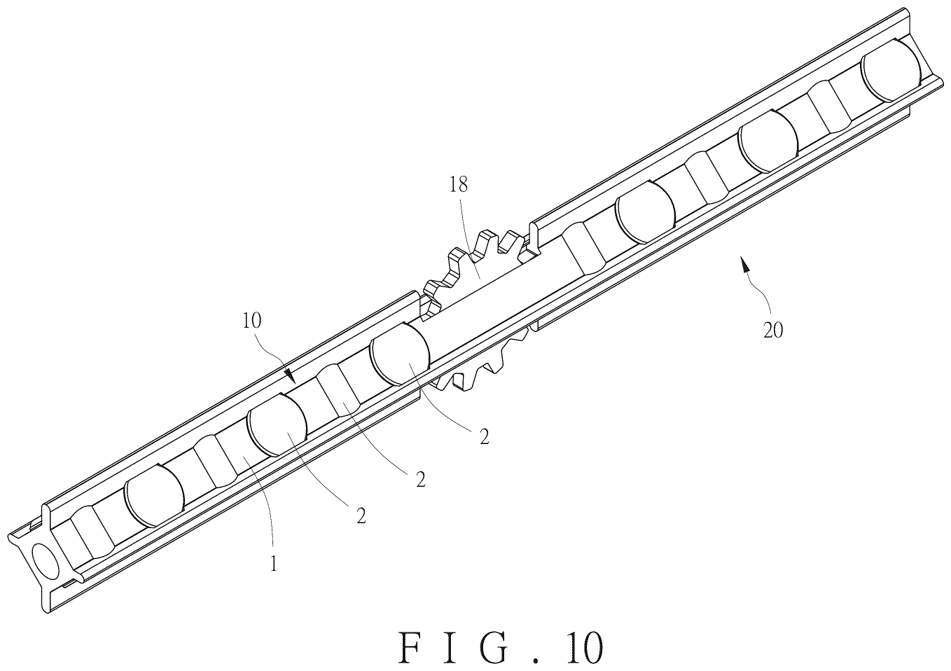

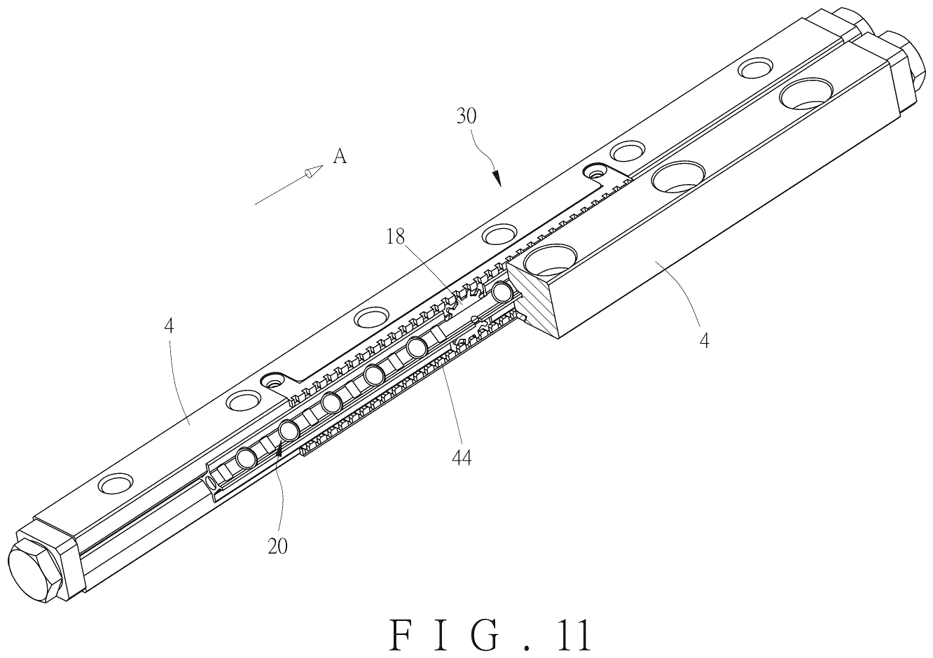

Referring to FIG. 10 and FIG. 11, a plurality of rolling elements 2 are placed in the body 1 of the rolling element retainer 10 to form the slide member 20. The limited-stroke linear guide 30 of the second embodiment of the present invention has a toothed groove 44 extending along the axial direction A on each of the two fixed-length rails 4. When the slide member 20 is mounted between the two fixed-length rails 4, the toothed wheel 18 meshes with the toothed groove 44. Thereby, through the engagement of the toothed wheel 18 and the toothed groove 44, when the two fixed-length rails 4 move relative to each other, the slide member 20 can be kept in place to slide relative to the two fixed-length rails 4 without creeping.

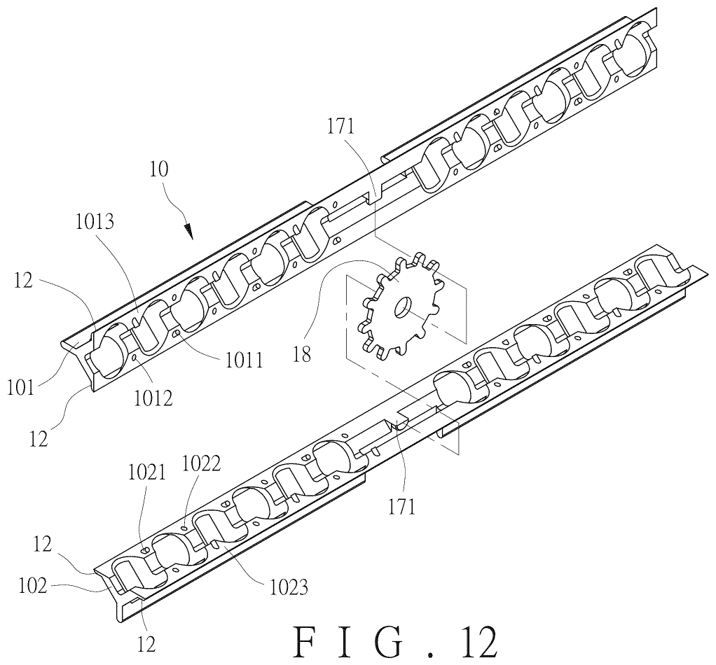

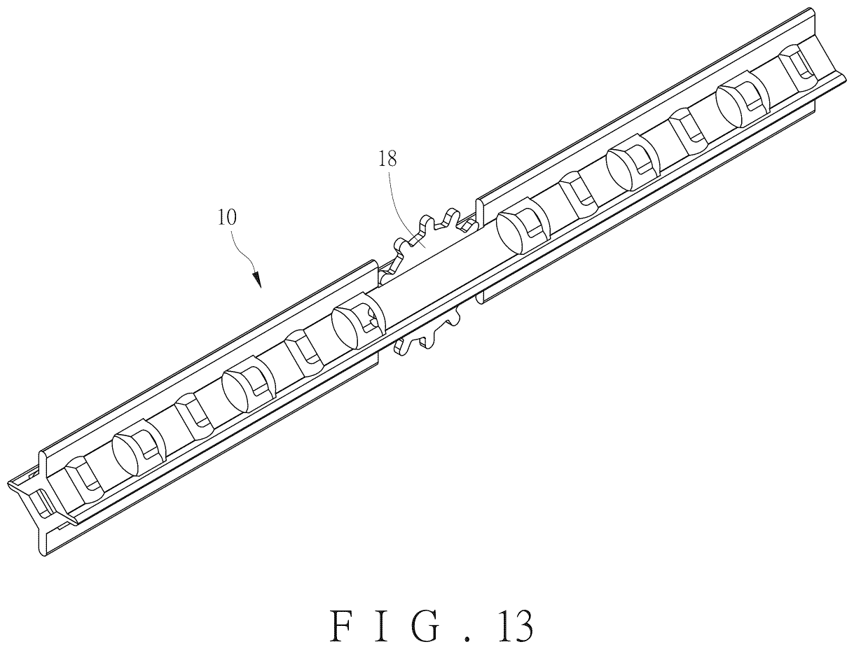

FIG. 12 and FIG. 13 illustrate a rolling element retainer 10 having a toothed wheel 18 according to a third embodiment of the present invention. The rolling element retainer 10 is an assembled rolling element retainer, and includes a first segment 101 and a second segment 102 extending along the linear path. The first segment 101 and the second segment 102 are coupled to each other on a coupling surface by means of corresponding coupling portions to form the rolling element retainer 10. The coupling surface includes a first coupling surface 1013 on the first segment 101 and a second coupling surface 1023 on the second segment 102. In this embodiment, the first segment 101 and the second segment 102 are formed in this manner that the rolling element retainer 10 is bisected along the diagonal protruding portions 12 of the rolling element retainer 10 so that the opposite side of the first segment 101 and the opposite side of the second segment 102 in the tangential direction each have half of the protruding portion 12. After the first segment 101 and the second segment 102 are butted, the complete protruding portions 12 are formed. The coupling portions include a plurality of first protrusions 1011 and a plurality of first holes 1012 that are staggered and spaced from each other on the first coupling surface 1013 as well as a plurality of second protrusions 1021 and a plurality of second holes 1022 that are staggered and spaced from each other on the second coupling surface 1023. The first segment 101 and the second segment 102 are coupled to form the rolling element retainer 10. In this embodiment, half of the spindle 171 is integrally formed with each of the first segment 101 and the second segment 102.

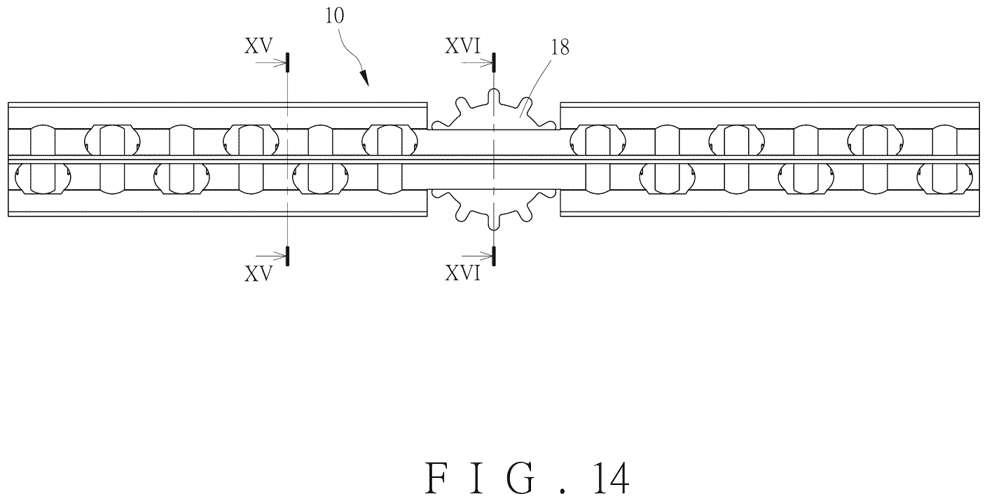

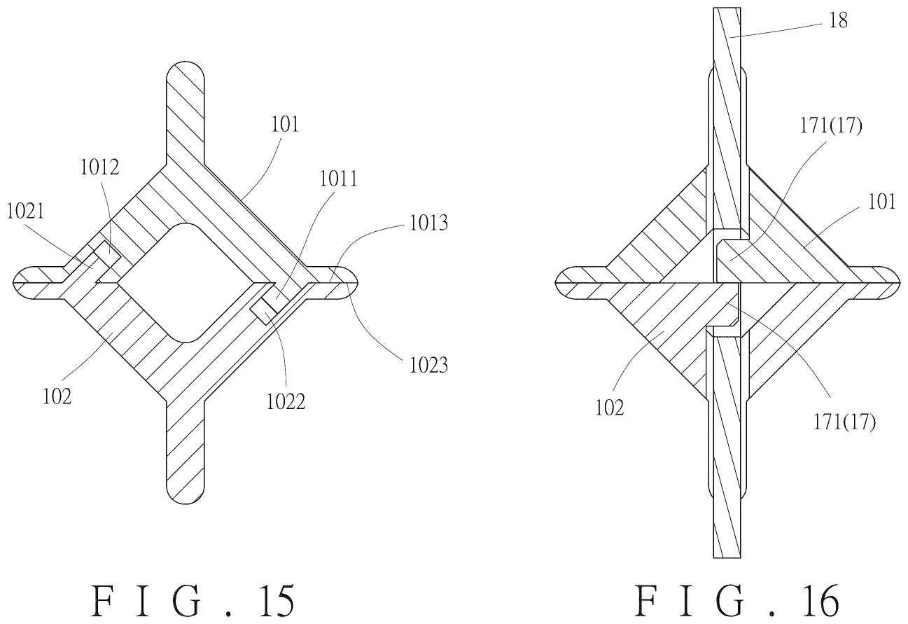

As shown in FIG. 14, FIG. 15 and FIG. 16, when the first segment 101 and the second segment 102 are butted, the first coupling surface 1013 and the second coupling surface 1023 are attached to each other, the first protrusions 1011 are inserted in the second holes 1022, the second protrusions 1021 are inserted in the first holes 1012, and the half spindles 171 of the first segment 101 and the second segment 102 are joined to form the spindle 17 of the toothed wheel 18. In this embodiment, after the rolling elements 2 and the spindle 17 are placed on the first segment 101 or the second segment 102, the second segment 102 or the first segment 101 is assembled. In this way, the rolling element retainer 10 can be shaped and manufactured with ease, and the rolling elements 2 and the spindle 17 can be installed with ease.

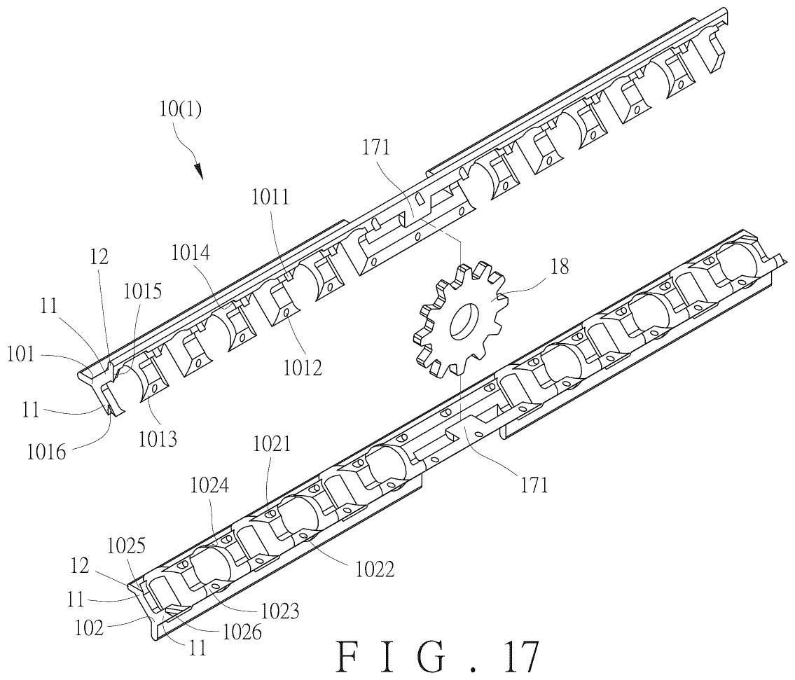

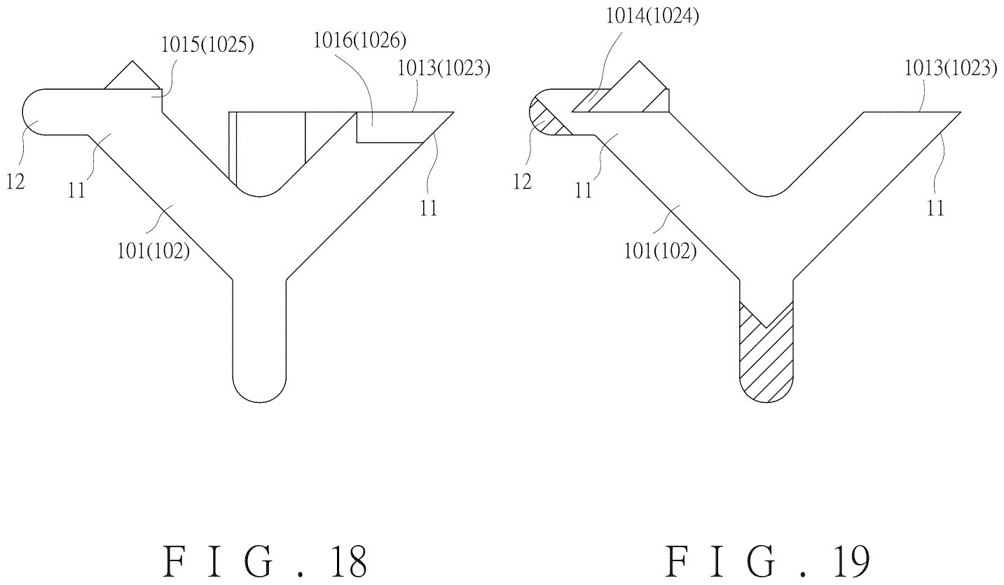

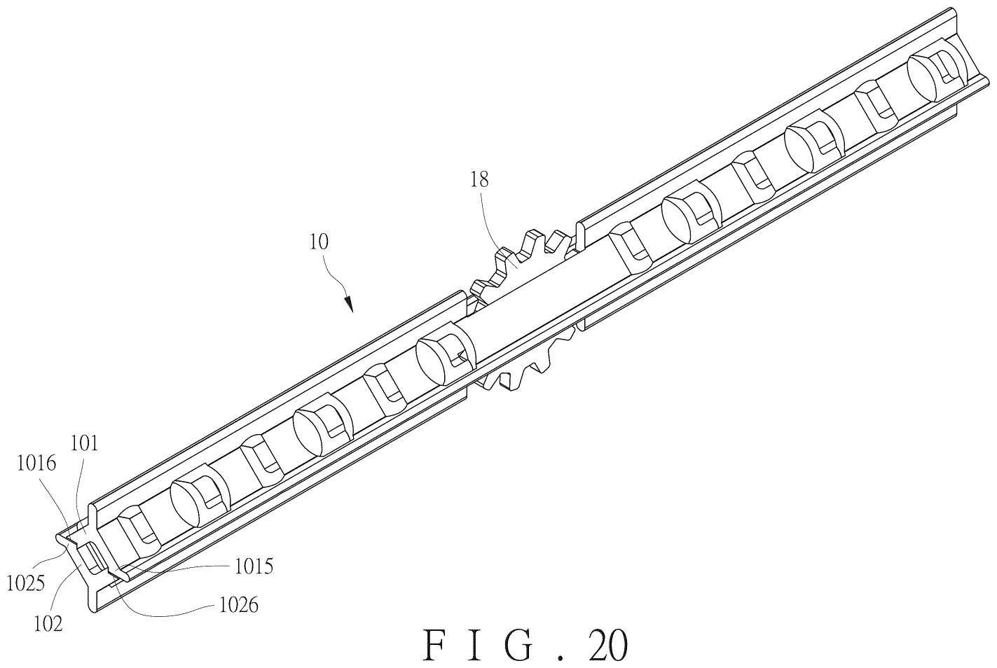

FIG. 17, FIG. 18 and FIG. 19 illustrate a rolling element retainer 10 having a toothed wheel 18 according to a fourth embodiment of the present invention. The rolling element retainer 10 is an assembled rolling element retainer, and includes a first segment 101 and a second segment 102 extending along the linear path. The first segment 101 and the second segment 102 are coupled to each other on a coupling surface by means of corresponding coupling portions to form the rolling element retainer 10. The coupling surface includes a first coupling surface 1013 on the first segment 101 and a second coupling surface 1023 on the second segment 102. In this embodiment, the first segment 101 and the second segment 102 are formed in this manner that the rolling element retainer 10 is bisected along the diagonal protruding portions 12 of the rolling element retainer 10. In this embodiment, the first segment 101 and the second segment 102 each have a complete protruding portion 12 on the opposite sides in the tangential direction. In this embodiment, since the body 1 of the rolling element retainer 10 is polygonal and the protruding portions 12 protrude from the respective corners 11, a first recessed portion 1014 is formed on the protruding portion 12 of the first segment 101 in the tangential direction to accommodate the corner 11 on the opposite side of the second segment 102 when the first segment 101 and the second segment 102 are butted, and a second recessed portion 1024 is formed on the protruding portion 12 of the second segment 102 in the tangential direction to accommodate the corner 11 on the opposite side of the first segment 101 when the first segment 101 and the second segment 102 are butted. In this embodiment, two opposite ends of the first segment 101 has a first engaging block 1015 extending from the protruding portion 12 and a corresponding first engaging groove 1016 opposite to the first engaging block 1015, and two opposite ends of the second segment 102 has a second engaging block 1025 extending from the protruding portion 12 and a corresponding second engaging groove 1026 opposite to the second engaging block 1026. The coupling portions include a plurality of first protrusions 1011 and a plurality of first holes 1012 that are arranged adjacently on the first coupling surface 1013 as well as a plurality of second protrusions 1021 and a plurality of second holes 1022 that are arranged adjacently on the second coupling surface 1023. The first segment 101 and the second segment 102 are coupled to form the rolling element retainer 10. In this embodiment, half of the spindle 171 is integrally formed with each of the first segment 101 and the second segment 102. (Since the first segment 101 and the second segment 102 are symmetrical, the first segment 101 can be turned over 180 degrees during production to serve as the second segment 102, both the first segment 101 and the second segment 102 are labelled in FIG. 18 and FIG. 19.)

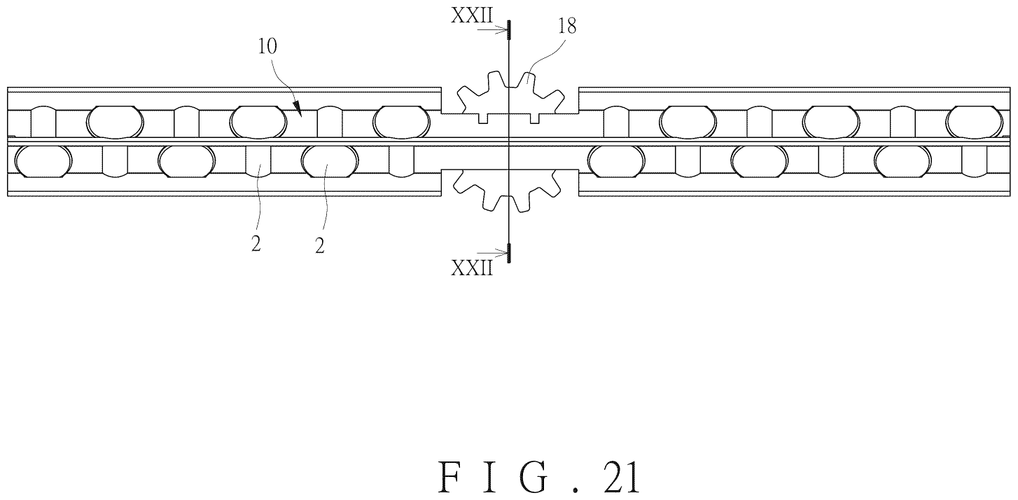

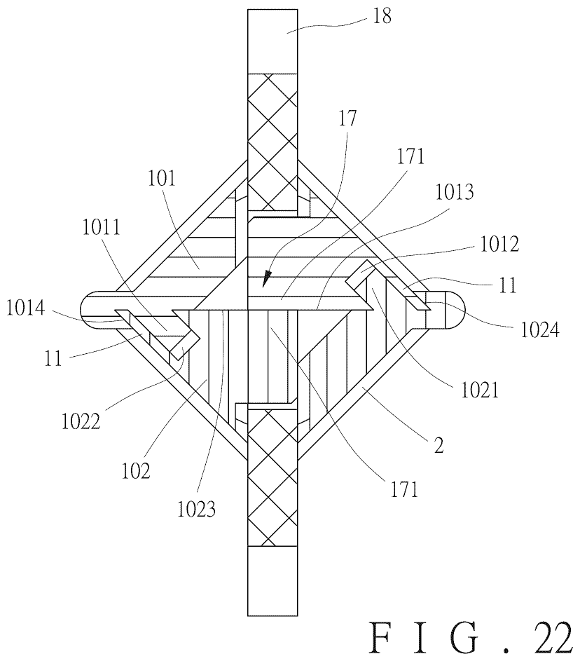

As shown in FIG. 20, FIG. 21 and FIG. 22, when the first segment 101 and the second segment 102 are butted, the first engaging block 1015 at the end of the first segment 101 is engaged in the second engaging groove 1026 at the end of the second segment 102, and the second engaging block 1025 at the end of the second segment 102 is engaged in the first engaging groove 1016 at the end of the first segment 101. The first coupling surface 1013 and the second coupling surface 1023 are attached to each other, such that the first recessed portion 1014 of the first segment 101 accommodates the corner 11 on the opposite side of the second segment 102, and the second recessed portion 1024 of the second segment 102 accommodates the corner 11 on the opposite side of the first segment 101. The first protrusions 1011 are inserted in the second holes 1022, the second protrusions 1021 are inserted in the first holes 1012, and the half spindles 171 of the first segment 101 and the second segment 102 are joined to form the spindle 17 of the toothed wheel 18. In this embodiment, after the rolling elements 2 and the spindle 17 are placed on the first segment 101 or the second segment 102, the second segment 102 or the first segment 101 is assembled. In this way, the rolling element retainer 10 can be shaped and manufactured with ease, and the rolling elements 2 and the spindle 17 can be installed with ease.

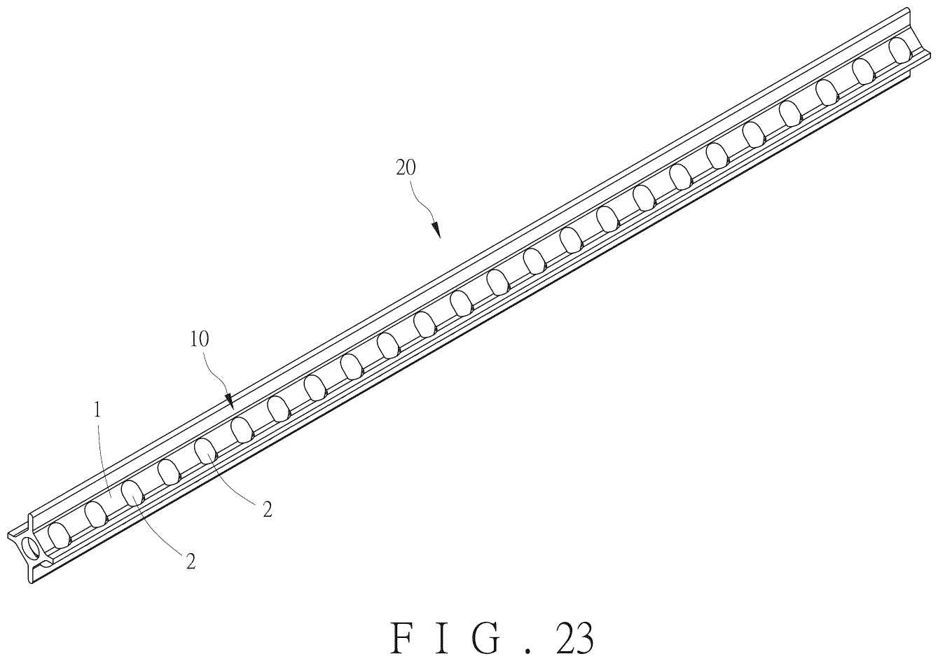

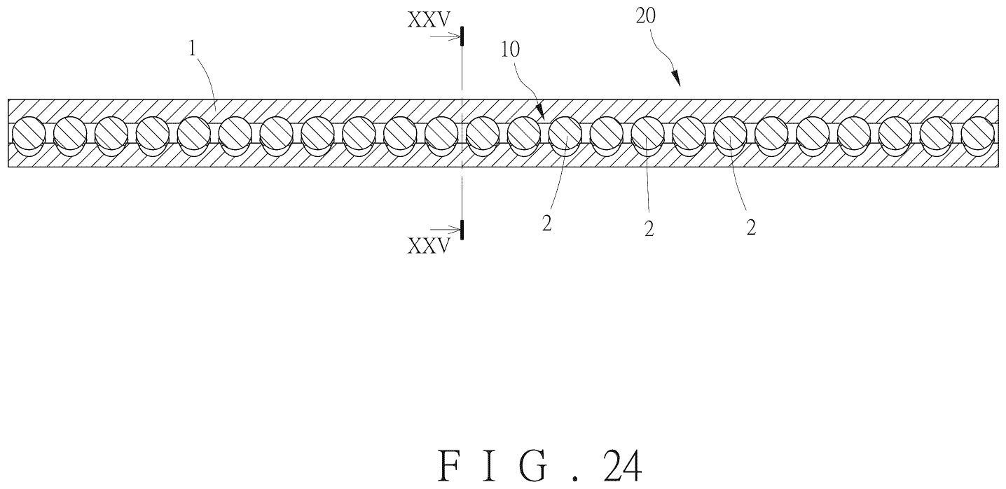

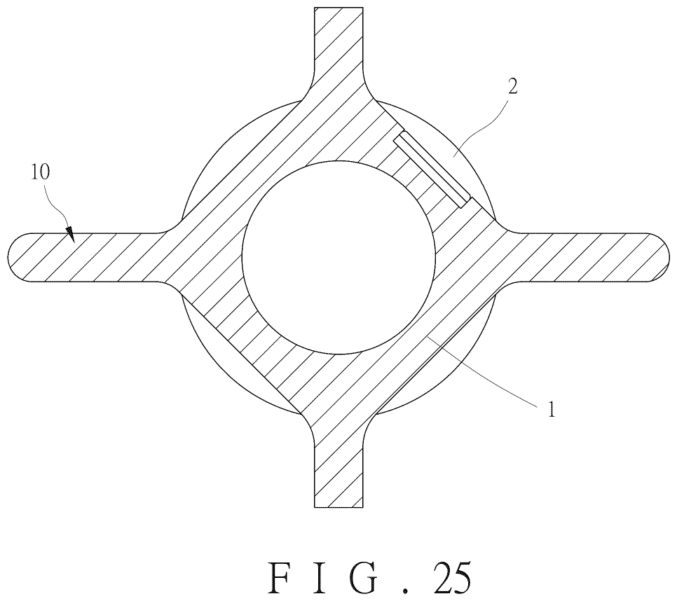

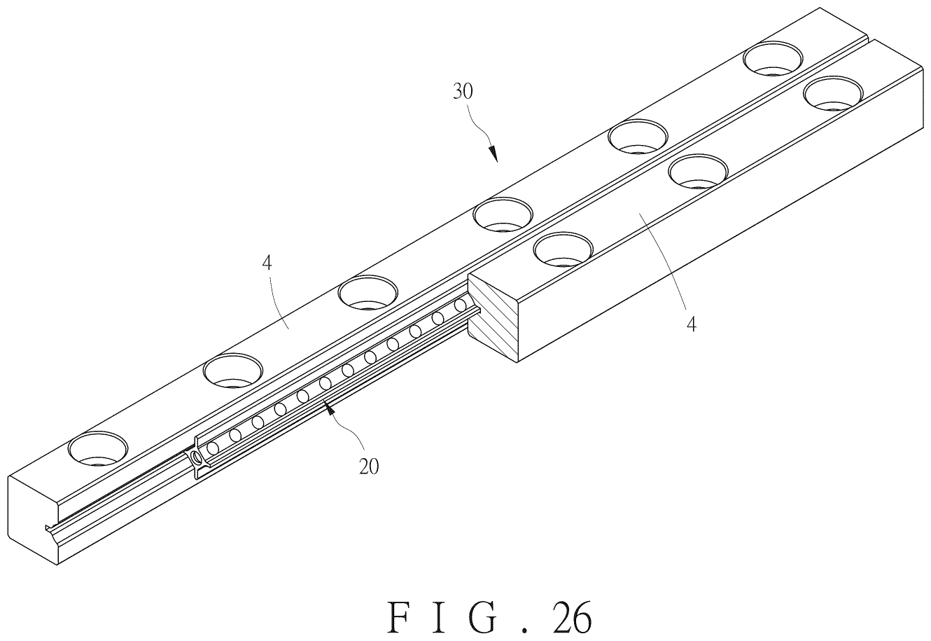

FIGS. 23 to 25 illustrate a rolling element retainer 10 and a slide member 20 according to a fifth embodiment of the present invention. Unlike the above-mentioned embodiments, the rolling elements 2 of this embodiment are balls. This embodiment illustrates that the present invention may use rollers and balls as the rolling elements 2, which are most commonly used in linear motion slide rails.

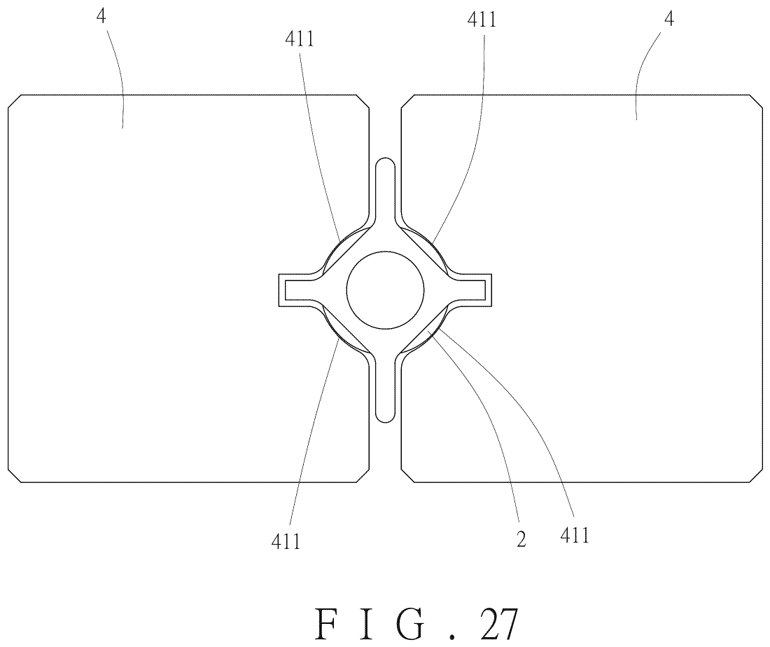

Referring to FIG. 26 and FIG. 27, the limited-stroke linear guide 30 according to the fifth embodiment of the present invention includes two fixed-length rails 4 and the slide member 20 mounted between the two fixed-length rails 4. The rolling elements 2 roll along the raceway surfaces 411 to assist the two fixed-length rails 4 in moving relative to each other.

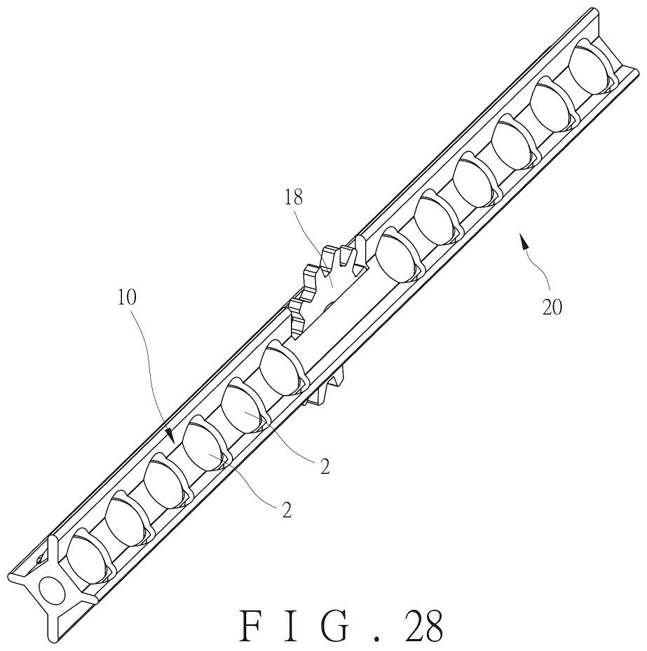

FIG. 28 illustrates a rolling element retainer 10 and a slide member 20 according to a sixth embodiment of the present invention. The rolling elements 2 of this embodiment are balls, and a toothed wheel 18 is provided on the rolling element retainer 10.

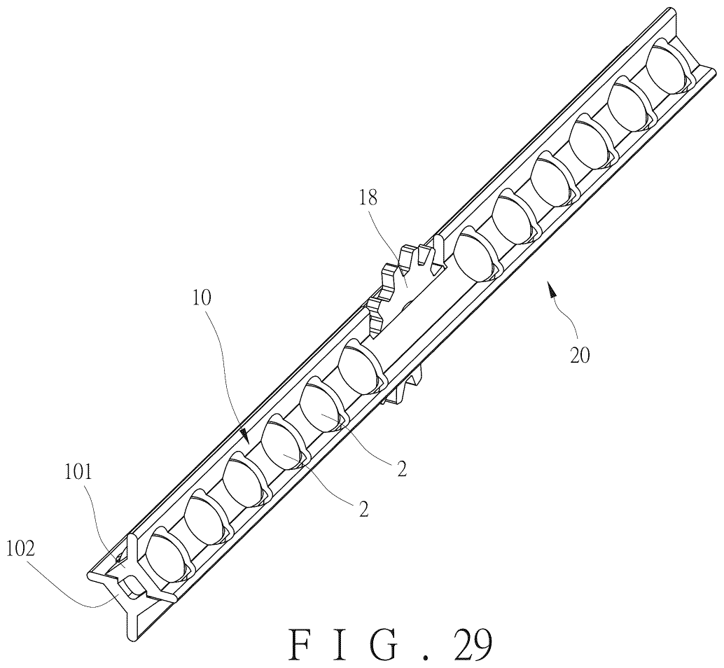

FIG. 29 illustrates a rolling element retainer 10 and a slide member 20 according to a seventh embodiment of the present invention. The rolling elements 2 of this embodiment are balls, and a toothed wheel 18 is provided on the rolling element retainer 10. The rolling element retainer 10 is composed of the first segment 101 and the second segment 102 that are butted together.

Although particular embodiments of the present invention have been described in detail for purposes of illustration, various modifications and enhancements may be made without departing from the spirit and scope of the present invention. Accordingly, the present invention is not to be limited except as by the appended claims.

What is claimed is:

1. A rolling element retainer, comprising:
a body, extending along a path, in a longitudinal direction, the body having a polygonal profile and at least four protruding portions protruding away from the body;
a plurality of accommodating holes, distributed in the body along the path and located among the protruding portions, the accommodating holes being spaced apart by a distance, the accommodating holes each accommodating a rolling element;
a plurality of apertures, formed on the body and located between the accommodating holes, the apertures communicating with the accommodating holes, the apertures being configured for storing lubricating grease or a porous lubricant;
wherein at least one of the protruding portions extends along the path and spans all the adjacent accommodating holes.

2. The rolling element retainer as claimed in claim 1, wherein the accommodating holes each have a width slightly greater than that of the rolling element, the accommodating holes each have an opening on the body, the opening has a width slightly less than that of the rolling element, the rolling element is placed in the accommodating hole via the opening by applying force, without falling off freely, and the rolling element has a rolling surface extending out of the body.

3. The rolling element retainer as claimed in claim 1, wherein the rolling element retainer is composed of a first segment and a second segment, and the first segment and the second segment extend along the path and are coupled to each other on a coupling surface by means of corresponding coupling portions.

4. The rolling element retainer as claimed in claim 1, wherein a spindle is integrally formed with the body in the longitudinal direction, a rotatable toothed wheel is pivotally connected to the spindle, the body has a notch corresponding in position to the toothed wheel, and the toothed wheel partially extends out of the notch.

5. The rolling element retainer as claimed in claim 4, wherein the rolling element retainer is composed of a first segment and a second segment, the first segment and the second segment extend along the path and are coupled to each other on a coupling surface by means of corresponding coupling portions, and the coupling surface is parallel to an axis of the toothed wheel.

6. The rolling element retainer as claimed in claim 1, wherein the path is a straight path or a curved path.

7. A slide member, comprising the rolling element retainer as claimed in claim 1, wherein the accommodating holes each accommodate the rolling element.

8. The slide member as claimed in claim 7, wherein the rolling element is a roller or a ball.

9. The slide member as claimed in claim 7, wherein rolling axes of adjacent ones of the rolling elements in the accommodating holes are staggered with respect to each other.

10. A limited-stroke linear guide, comprising the rolling element retainer as claimed in claim 1 and two fixed-length rails, wherein the accommodating holes each accommodate the rolling element, opposite sides of the two fixed-length rails each have a raceway groove, the raceway grooves of the two fixed-length rails define a raceway space in the longitudinal direction, the raceway space has a contour corresponding to that of the rolling element retainer; the rolling element retainer is disposed in the raceway space, the rolling element rolls along the raceway groove; the raceway space is formed with a rail gap and a receiving groove in the longitudinal direction, and the protruding portions are located in the rail gap and the receiving groove.

11. The limited-stroke linear guide as claimed in claim 10, the accommodating holes each have a width slightly greater than that of the rolling element, the accommodating holes each have an opening on the body, the opening has a width slightly less than that of the rolling element, the rolling element is placed in the accommodating hole via the opening by applying force, without falling off freely, and the rolling element has a rolling surface extending out of the body.

12. The limited-stroke linear guide as claimed in claim 10, wherein the rolling element retainer is composed of a first segment and a second segment, and the first segment and the second segment extend along the path and are coupled to each other on a coupling surface by means of corresponding coupling portions.

13. The limited-stroke linear guide as claimed in claim 10, wherein a spindle is integrally formed with the body in the longitudinal direction, a rotatable toothed wheel is pivotally connected to the spindle, the body has a notch corresponding in position to the toothed wheel, and the toothed wheel partially extends out of the notch.

14. The limited-stroke linear guide as claimed in claim 13, wherein the rolling element retainer is composed of a first segment and a second segment, the first segment and the second segment extend along the path and are coupled to each other on a coupling surface by means of corresponding coupling portions, and the coupling surface is parallel to an axis of the toothed wheel.

15. The limited-stroke linear guide as claimed in claim 10, wherein the path is a straight path or a curved path.

16. The limited-stroke linear guide as claimed in claim 10, wherein the two fixed-length rails each have a toothed groove corresponding to the toothed wheel, and the toothed wheel meshes with the toothed groove.

17. The limited-stroke linear guide as claimed in claim 11, wherein the two fixed-length rails each have a toothed groove corresponding to the toothed wheel, and the toothed wheel meshes with the toothed groove.

18. The limited-stroke linear guide as claimed in claim 12, wherein the two fixed-length rails each have a toothed groove corresponding to the toothed wheel, and the toothed wheel meshes with the toothed groove.

19. The limited-stroke linear guide as claimed in claim 13, wherein the two fixed-length rails each have a toothed groove corresponding to the toothed wheel, and the toothed wheel meshes with the toothed groove.

20. The limited-stroke linear guide as claimed in claim 14, wherein the two fixed-length rails each have a toothed groove corresponding to the toothed wheel, and the toothed wheel meshes with the toothed groove.
